(19) United States
(12) Patent Application Publication
(10) Pub. No.: US 2024/0211301 A1
(43) Pub. Date: Jun. 27, 2024

(54) COMPUTER-READABLE RECORDING MEDIUM STORING DATA CONTROL PROGRAM, DATA CONTROL METHOD, AND INFORMATION PROCESSING APPARATUS

(71) Applicant: Fujitsu Limited, Kawasaki-shi (JP)

(72) Inventor: Jun KATO, Kawasaki (JP)

(73) Assignee: Fujitsu Limited, Kawasaki-shi (JP)

(21) Appl. No.: 18/463,375

(22) Filed: Sep. 8, 2023

(30) Foreign Application Priority Data
Dec. 21, 2022 (JP) 2022-204031

(51) Int. Cl. G06F 9/48; G06F 9/50

(52) U.S. Cl. CPC G06F 9/4812; G06F 9/5027

(57) ABSTRACT

A non-transitory computer-readable recording medium stores a program for causing a computer to execute a data control process in an information processing apparatus including: a plurality of first processors; and a second processor that has a processing speed slower than the processing speed of the plurality of first processors. The process includes causing the second processor to execute processing that determines an interrupt destination for interrupt processing from among the plurality of first processors based on a state of each of the plurality of first processors.

### CROSS-REFERENCE TO RELATED APPLICATION

This application is based upon and claims the benefit of priority of the prior Japanese Patent Application No. 2022-204031, filed on Dec. 21, 2022, the entire contents of which are incorporated herein by reference.

### FIELD

The embodiments discussed herein are related to a data control program, a data control method, and an information processing apparatus.

### BACKGROUND

High performance computing (HPC) is known as a technique capable of executing high-speed data processing and complex calculation. Since an HPC environment is based on the premise that a user is capable of using a supercomputer, a hurdle for the user to get started is high, and it is also difficult for a manufacturer side to obtain new users.

Japanese Laid-open Patent Publication No. 2007-148746, Japanese Laid-open Patent Publication No. 2000-331150, U.S. Pat. No. 6,189,065, and U.S. Patent Application Publication No. 2004/0054834 are disclosed as related art.

### SUMMARY

According to an aspect of the embodiments, a non-transitory computer-readable recording medium stores a program for causing a computer to execute a data control process in an information processing apparatus including: a plurality of first processors; and a second processor that has a processing speed slower than the processing speed of the plurality of first processors. The process includes causing the second processor to execute processing that determines an interrupt destination for interrupt processing from among the plurality of first processors based on a state of each of the plurality of first processors.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram schematically illustrating a configuration of an information processing apparatus as an example of a first embodiment;

FIG. 2 is a hardware configuration diagram of the information processing apparatus as an example of the first embodiment;

FIG. 3 is a diagram schematically illustrating a hardware configuration of a network interface of the information processing apparatus as an example of the first embodiment;

FIG. 4 is a diagram for explaining a virtual port in the information processing apparatus as an example of the first embodiment;

FIG. 5 is a diagram illustrating an outline of a process in the information processing apparatus as an example of the first embodiment;

FIG. 6 is a diagram exemplifying control data in the information processing apparatus as an example of the first embodiment;

FIG. 7 is a diagram for explaining processing of an interrupt processing distribution unit in the information processing apparatus as an example of the first embodiment;

FIG. 8 is a diagram for explaining an outline of interrupt distribution processing in the information processing apparatus as an example of the first embodiment;

FIG. 9 is a diagram for explaining an outline of the interrupt distribution processing in the information processing apparatus as an example of the first embodiment;

FIG. 10 is a flowchart for explaining processing of a host profile acquisition unit in the information processing apparatus as an example of the first embodiment;

FIG. 11 is a flowchart for explaining processing of an update detection unit in the information processing apparatus as an example of the first embodiment;

FIG. 12 is a diagram for explaining processing of an interrupt processing distribution unit in an information processing apparatus as an example of a second embodiment; and

FIG. 13 is a diagram illustrating synchronization timing among a plurality of MPI processes in an HPC application.

### DESCRIPTION OF EMBODIMENTS

In view of the above, in recent years, it has been achieved to operate an HPC application in a cloud service, which has greatly reduced the barrier to entry into the HPC. Since a central processing unit (CPU), a memory capacity, and the like may be adjusted according to a workload in the case of using the cloud, it becomes easier to achieve a target at a low cost and to optimize cost performance.

The HPC application commonly performs parallel processing using the Message Passing Interface (MPI).

For example, many applications in Kubernetes, which is known as a cloud virtual infrastructure, employ the microservice architecture, and combine a plurality of independent small microservices to perform processing basically sequentially.

While multiple MPI processes perform processing in parallel in the HPC application, they do not run in parallel on a continuous basis, and synchronization needs to be carried out among the multiple MPI processes at some timing.

When there is a difference in timing at which the MPI processes synchronize in the HPC application, rate limiting to the latest process is carried out. Therefore, even if the processing of the multiple MPI processes is written in exactly the same manner at the application level, a deviation occurs due to operating system (OS) noise. The OS noise is a generic term for application execution delays caused by processing other than an application, such as an OS daemon, a kernel daemon, interrupt processing, and the like. Since the OS noise is generated according to a load status of a processor, it may be referred to as processor noise.

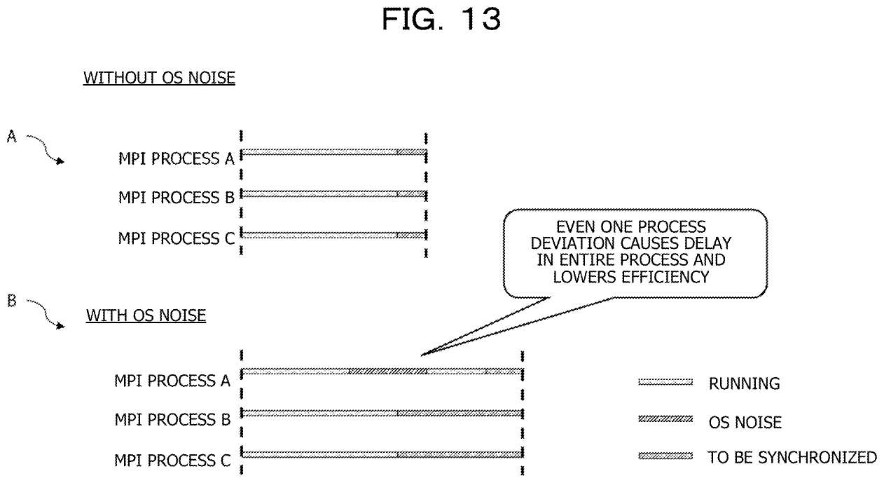

FIG. 13 is a diagram illustrating synchronization timing among a plurality of MPI processes in the HPC application, in which a reference sign A indicates an example without OS noise and a reference sign B indicates an example with OS noise.

In the example indicated by the reference sign B in FIG. 13, OS noise is generated in an MPI process A, which causes the synchronization waiting time of an MPI process B and an MPI process C to be longer, whereby the entire process delays. As a result, completion of the entire process delays as compared with the case without OS noise, which lowers efficiency.

One of the causes of the OS noise is an interrupt. In an information processing apparatus, notification of data reception is commonly made through an interrupt. When an interrupt occurs, a running process is suspended, and processing for the interrupt is performed.

Note that, for example, in a case of New API (NAPI) of Linux (registered trademark), not all interrupts proceed as polling is performed when the number of interrupts increases, but interrupt processing occurs to some extent.

In one aspect, an object of the embodiments is to reduce OS noise.

Hereinafter, embodiments of the present data control program, data control method, and information processing apparatus will be described with reference to the drawings. Note that the embodiments to be described below are merely examples, and there is no intention to exclude application of various modifications and techniques not explicitly described in the embodiments. For example, the present embodiments may be variously modified and implemented in a range without departing from the spirit thereof. Furthermore, each drawing is not intended to include only components illustrated in the drawing, and may include another function and the like.

### (I) Description of First Embodiment

### (A) Configuration

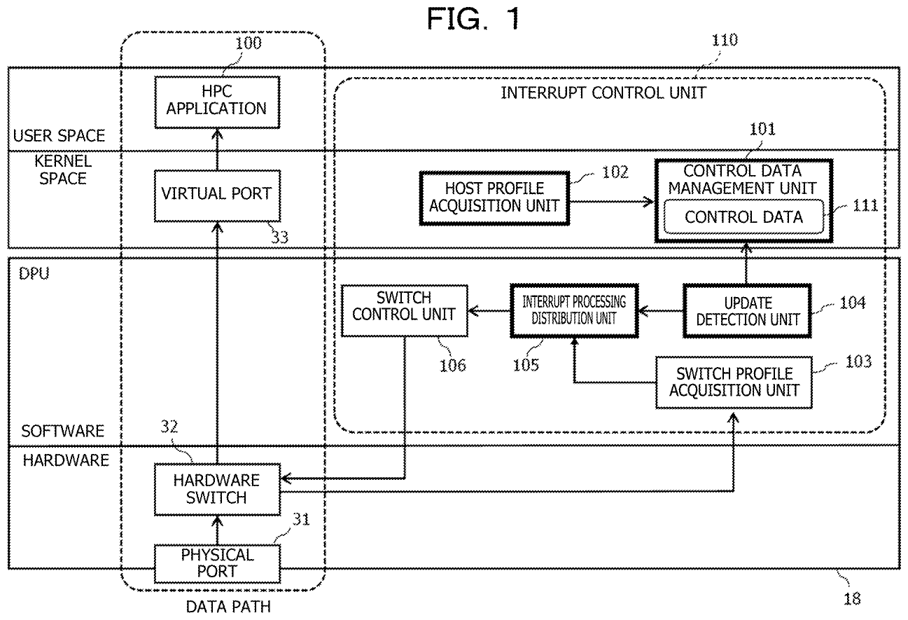

FIG. 1 is a diagram schematically illustrating a configuration of an information processing apparatus 1 as an example of a first embodiment.

This information processing apparatus 1 implements a cloud computing environment, and runs an HPC application 100 in a container implemented by container-based virtualization technology, for example. A cloud virtual infrastructure in the information processing apparatus 1 may be, for example, Kubernetes.

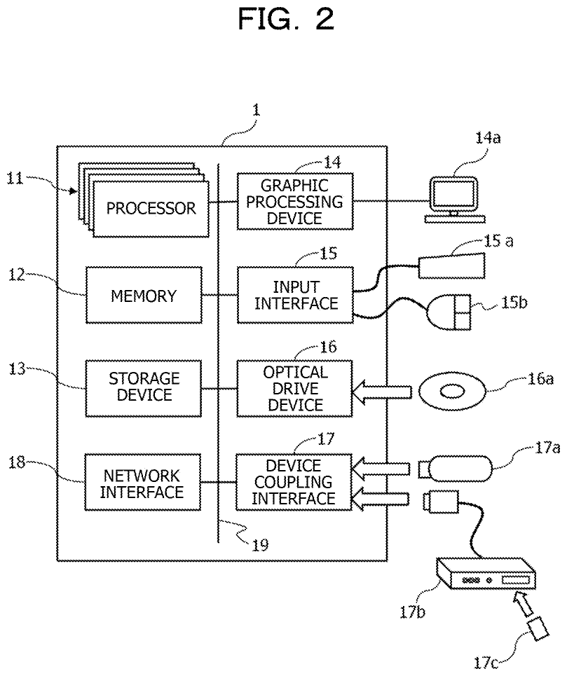

FIG. 2 is a hardware configuration diagram of the information processing apparatus 1 as an example of the first embodiment.

The information processing apparatus 1 includes, for example, a processor 11, a memory 12, a storage device 13, a graphic processing device 14, an input interface 15, an optical drive device 16, a device coupling interface 17, and a network interface 18 as components. Those components 11 to 18 are configured to be mutually communicable via a bus 19.

The processor (processing unit) 11 is a first processor that controls the entire information processing apparatus 1. In the present first embodiment, a multiprocessor including a plurality of the processors 11 is configured. Furthermore, the processor 11 may be a multi-core processor. The processor 11 may also be, for example, any one of a central processing unit (CPU), a micro processing unit (MPU), a digital signal processor (DSP), an application specific integrated circuit (ASIC), a programmable logic device (PLD), and a field programmable gate array (FPGA). Furthermore, the processor 11 may also be a combination of two or more types of elements of the CPU, MPU, DSP, ASIC, PLD, and FPGA.

Hereinafter, an exemplary case where the processor 11 is a CPU will be described. Hereinafter, the processor 11 may be referred to as a CPU 11.

Then, at least one of the plurality of processors 11 executes a program (data control program, OS program) recorded in a computer-readable non-transitory recording medium, for example, thereby implementing functions as a control data management unit 101 and a host profile acquisition unit 102 exemplified in FIG. 1.

Furthermore, each of the processors 11 runs the HPC application 100, whereby the information processing apparatus 1 implements a function as HPC. The processor 11 may be referred to as a host processor or simply as a host.

The program in which processing content to be executed by the information processing apparatus 1 is described may be recorded in various recording media. For example, the program to be executed by the information processing apparatus 1 may be stored in the storage device 13. The processor 11 loads at least a part of the program in the storage device 13 into the memory 12, and executes the loaded program.

Furthermore, the program to be executed by the information processing apparatus 1 (processor 11) may be recorded in a non-transitory portable recording medium such as an optical disc 16a, a memory device 17a, or a memory card 17c. The program stored in the portable recording medium may be executed after being installed in the storage device 13 under the control of the processor 11, for example. Furthermore, the processor 11 may directly read the program from the portable recording medium and execute the program.

The memory 12 is a storage memory including a read only memory (ROM) and a random access memory (RAM). The RAM of the memory 12 is used as a main storage device of the information processing apparatus 1. The RAM temporarily stores at least a part of the program to be executed by the processor 11. Furthermore, the memory 12 stores various types of data needed for processing by the processor 11. This memory 12 may store control data 111.

The storage device 13 is a storage device such as a hard disk drive (HDD), a solid state drive (SSD), a storage class memory (SCM), or the like, and stores various types of data. The storage device 13 may store the control data 111.

Note that a semiconductor storage device such as an SCM, a flash memory, or the like may be used as an auxiliary storage device. Furthermore, redundant arrays of inexpensive disks (RAID) may be configured using a plurality of the storage devices 13.

The graphic processing device 14 is coupled to a monitor 14a. The graphic processing device 14 displays an image on a screen of the monitor 14a in accordance with a command from the processor 11. Examples of the monitor 14a include a display device using a cathode ray tube (CRT), a liquid crystal display device, and the like.

The input interface 15 is coupled to a keyboard 15a and a mouse 15b. The input interface 15 transmits signals sent from the keyboard 15a and the mouse 15b to the processor 11. Note that the mouse 15b is an exemplary pointing device, and another pointing device may also be used. Examples of the another pointing device include a touch panel, a tablet, a touch pad, a track ball, and the like.

The optical drive device 16 reads data recorded in the optical disc 16a using laser light or the like. The optical disc 16a is a non-transitory portable recording medium in which data is recorded in a readable manner by reflection of light. Examples of the optical disc 16a include a digital versatile disc (DVD), a DVD-RAM, a compact disc read only memory (CD-ROM), a CD-recordable (R)/rewritable (RW), and the like.

The device coupling interface 17 is a communication interface for coupling a peripheral device to the information processing apparatus 1. For example, the device coupling interface 17 may be coupled to the memory device 17a and a memory reader/writer 17b. The memory device 17a is a non-transitory recording medium equipped with a function of communicating with the device coupling interface 17, for example, a universal serial bus (USB) memory. The memory reader/writer 17b writes data to the memory card 17c or reads data from the memory card 17c. The memory card 17c is a card-type non-transitory recording medium.

The network interface 18 is coupled to a network. The network interface 18 transmits and receives data via the network. The network interface 18 may be referred to as a network interface card (NIC).

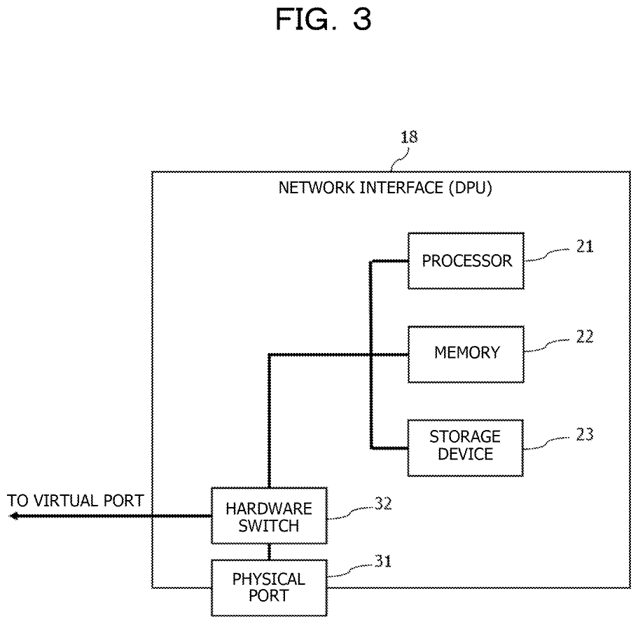

FIG. 3 is a diagram schematically illustrating a hardware configuration of the network interface 18 of the information processing apparatus 1 as an example of the first embodiment.

The network interface 18 exemplified in FIG. 3 is a data processing unit (DPU) including a processor 21, a memory 22, a storage device 23, a physical port 31, and a hardware switch 32. The network interface 18 may be referred to as a DPU 18.

The processor (processing unit) 21 is a second processor that controls the entire network interface 18. The processor 21 may be, for example, an Advanced RISC Machines (ARM) processor. The processor 21 has a processing speed slower than that of the processor 11 described above.

Note that the processor 21 is not limited to this. For example, the processor 21 may be a multiprocessor or a multi-core processor. Furthermore, the processor 21 may also be, for example, any one of the CPU, MPU, DSP, ASIC, PLD, and FPGA. Furthermore, the processor 21 may also be a combination of two or more types of elements of the CPU, MPU, DSP, ASIC, PLD, and FPGA.

Then, the processor 21 executes a program (DPU data control program) recorded in a computer-readable non-transitory recording medium, for example, thereby implementing functions as a switch profile acquisition unit 103, an update detection unit 104, an interrupt processing distribution unit 105, and a switch control unit 106 exemplified in FIG. 1. Furthermore, the switch profile acquisition unit 103, the update detection unit 104, the interrupt processing distribution unit 105, and the switch control unit 106 in the DPU 18, and the control data management unit 101 and the host profile acquisition unit 102 of the host cooperate to function as an interrupt control unit 110 that controls an interrupt to a virtual port 33.

The program in which processing content to be executed by the processor 21 is described may be recorded in various recording media. For example, the program to be executed by the processor 21 may be stored in the storage device 23. The processor 21 loads at least a part of the program in the storage device 23 into the memory 22, and executes the loaded program.

Furthermore, the program to be executed by the processor 21 may be recorded in a non-transitory portable recording medium such as the optical disc 16a, the memory device 17a, or the memory card 17c described above. The program stored in the portable recording medium may be executed after being installed in the storage device 23 under the control of the processor 11 or the processor 21, for example. Furthermore, the processor 21 may directly read the program from the portable recording medium and execute the program.

The memory 22 is a storage memory including a ROM and a RAM. The RAM of the memory 22 is used as a main storage device of the DPU 18. The RAM temporarily stores at least a part of the program to be executed by the processor 21. Furthermore, the memory 22 stores various types of data needed for processing by the processor 21. Furthermore, the memory 22 may store a switch profile (not illustrated) obtained by the switch profile acquisition unit 103 to be described later.

The storage device 23 is a storage device such as an HDD, an SSD, or an SCM, and stores various types of data. The storage device 23 may store a DPU data control program. Furthermore, the storage device 23 may store a switch profile (not illustrated) obtained by the switch profile acquisition unit 103.

The network interface 18 may be coupled to another information processing apparatus, a communication device, and the like via a network (not illustrated). For example, an information processing apparatus of a user who uses the cloud computing environment provided by the HPC application 100 may be coupled.

A packet is input to the physical port 31 from an external device (not illustrated). The hardware switch 32 has a switch profile (not illustrated), and transfers the packet input from the physical port 31 to the corresponding virtual port 33 according to a rule (processing method) set in the switch profile.

Note that, when a packet for which a rule is not set in the switch profile is input to the physical port 31, the hardware switch 32 temporarily transmits the packet to the processor 21. In the processor 21, rule setting for the packet is carried out by a virtual switch control function, and the setting is registered in the switch profile of the hardware switch 32. Thereafter, the hardware switch 32 transfers the packet to the corresponding virtual port 33 according to the rule registered in the switch profile. The virtual switch control function may be implemented using a known technique, which may be, for example, Open vSwitch. Furthermore, the function as the hardware switch 32 may also be implemented using a known technique, which may be, for example, E-Switch.

Furthermore, as illustrated in FIG. 1, the virtual port 33 is set in the present information processing apparatus 1, whereby a data path that couples the physical port 31, the hardware switch 32, the virtual port 33, and the HPC application 100 is formed as indicated by a reference sign A.

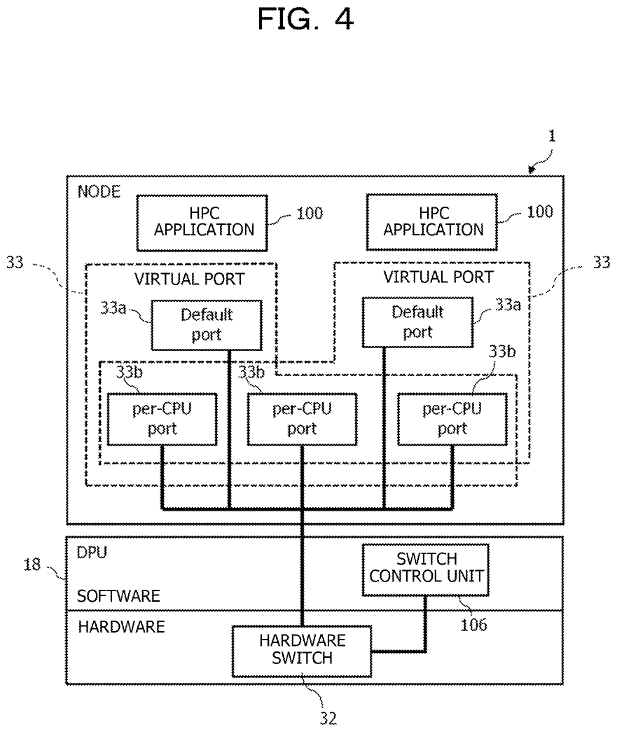

FIG. 4 is a diagram for explaining the virtual port 33 in the information processing apparatus 1 as an example of the first embodiment.

The virtual port 33 is a port used by the HPC application 100, and may be used to input interrupt notification from the DPU 18 to the HPC application 100.

The virtual port 33 includes a default port 33a and a per-CPU port 33b. Both of those default port 33a and per-CPU port 33b are coupled to the hardware switch 32. Hereinafter, the default port 33a may be referred to as a default port 33a, and the per-CPU port 33b may be referred to as a per-CPU port 33b.

Interrupt notification may be issued from the default port 33a to any processor (CPU) 11 of the plurality of processors (CPU) 11 included in the present information processing apparatus 1. However, it is determined by a packet header when Receive Side Scaling (RSS) is enabled. Hereinafter, “issuing interrupt notification” may be expressed as “interrupting”.

The per-CPU port 33b is a port provided specially for a specific CPU 11, and is used to input interrupt notification to the corresponding specific CPU 11. For example, from the per-CPU port 33b, the interrupt notification may be input only to the specific CPU 11 associated with the per-CPU port 33b.

In the present information processing apparatus 1, the same number of per-CPU ports 33b as the number of CPUs 11 are provided. Those multiple per-CPU ports 33b are shared between the virtual ports 33 (between the HPC applications 100).

The virtual switch control function described above sets the per-CPU ports 33b (per-processor virtual ports) corresponding to the plurality of individual processors 11.

In the present information processing apparatus 1, the default port 33a is normally used to interrupt the CPU 11. Then, as needed, interrupt notification to the specific CPU 11 is issued using the per-CPU port 33b for each flow.

For example, as will be described later, the switch control unit 106 changes the switch profile of the hardware switch 32, whereby the port (reception port) for issuing interrupt notification to the CPU 11 is changed from the default port 33a to the per-CPU port 33b.

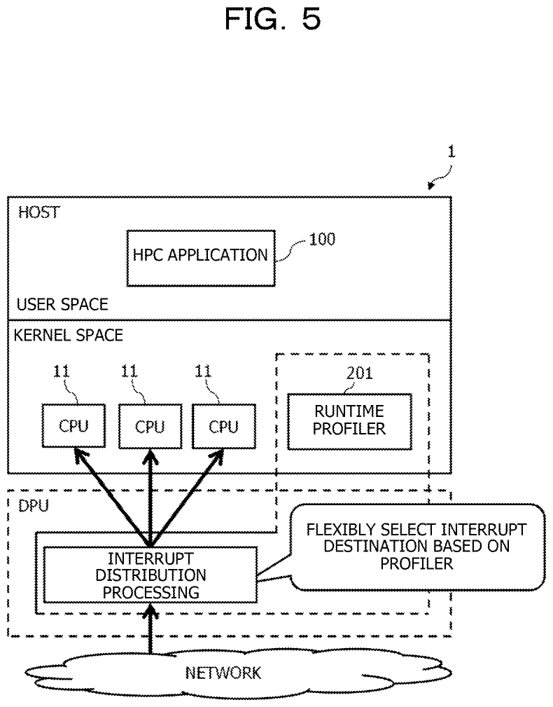

FIG. 5 is a diagram illustrating an outline of a process in the information processing apparatus 1 as an example of the first embodiment.

In the present information processing apparatus 1, an interrupt distribution processing function is offloaded to the DPU 18, and this interrupt distribution processing function cooperates with a runtime profiler 201 of the host to implement interrupt processing in consideration of the workload of the host.

For example, the interrupt processing distribution unit 105 flexibly selects an interrupt destination based on the profile of the host obtained by the host profile acquisition unit 102.

The present information processing apparatus 1 may be applied to, for example, storage control, or may be applied to data communication control.

The HPC application 100 runs in a user space of the host. The HPC application 100 may implement various types of arithmetic processing using, for example, a plurality of CPUs 11.

The host profile acquisition unit 102 obtains a usage status of each CPU 11 and a process execution status of each CPU 11.

The host profile acquisition unit 102 obtains a profile (performance profile) in the host. The profile in the host may be information indicating a processing status (load status) of each CPU 11. For example, the profile in the host may be a flow interrupt rate of each CPU 11.

The profile in the host is created by, for example, a host profile creation unit (not illustrated). At a time of creating a profile such as a usage status of the CPU 11, the host profile creation unit may also set a creation time and a counter value to be incremented each time the profile is created so that the latest profile may be identified. The update detection unit 104 to be described later may detect whether the profile of the host has been updated by referring to this counter value. The host profile creation unit may notify the update detection unit 104 of the updated latest profile.

Each CPU 11 may process packets in flow units. The packets to be processed by each CPU 11 may belong to any flow.

The flow interrupt rate is a frequency (rate) of occurrence of interrupts input to each CPU 11 by one or more flows generated by the HPC application 100. The interrupt rate may be the number of times per second of receiving a packet and being interrupted, and may be represented by, for example, a value in units of “interrupt/second”.

The function as the host profile acquisition unit 102 may be implemented by a runtime profiler. The runtime profiler may be referred to as a profiler of the host.

The control data management unit 101 manages the control data 111. The control data management unit 101 registers, in the control data 111, the profile (performance profile) in the host obtained by the host profile acquisition unit 102.

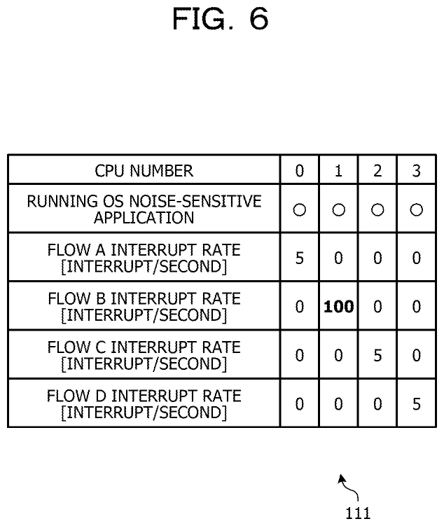

FIG. 6 is a diagram exemplifying the control data 111 in the information processing apparatus 1 as an example of the first embodiment.

The control data 111 is information indicating processing statuses (load statuses) of the plurality of CPUs 11. The control data 111 exemplified in FIG. 6 indicates, for each of the plurality of CPUs 11, information regarding whether an OS noise-sensitive application is running and a flow interrupt rate.

The information regarding whether the OS noise-sensitive application is running is information indicating an execution status of the HPC application 100, and indicates whether or not the CPU 11 is running the OS noise-sensitive HPC application 100. Whether or not each of a plurality of types of HPC applications 100 is OS noise-sensitive may be set in advance. Whether or not to be OS noise-sensitive may be determined based on the characteristics of each HPC application 100 or the like.

The example illustrated in FIG. 6 indicates that all the four CPUs 11 identified by CPU numbers 0 to 3 are running the OS noise-sensitive HPC application 100.

For example, it is indicated that one HPC application 100 is running using the four CPUs 11 with the CPU numbers 0 to 3 in the information processing apparatus 1.

Hereinafter, the CPU 11 with the CPU number 0 will be referred to as a CPU #0. Likewise, the CPU 11 with the CPU number 1, the CPU 11 with the CPU number 2, and the CPU 11 with the CPU number 3 will be referred to as a CPU #1, a CPU #2, and a CPU #3, respectively.

The example illustrated in FIG. 6 illustrates the interrupt rates of the interrupts input to the individual CPUs 11 by individual four flows of flows A to D. In the example illustrated in FIG. 6, in the CPU #1, the value of the interrupt rate of the flow B is 100 [interrupt/second], which may be seen that the interrupt rate is high. For example, the OS noise is likely to occur in the CPU #1.

In the example illustrated in FIG. 6, it may be seen that the CPU 11 as the input destination of the interrupt notification for the flow A is the CPU #0. The input destination of the interrupt notification may be referred to as an interrupt destination. Likewise, the interrupt destination for the flow B is the CPU #1, the interrupt destination for the flow C is the CPU #2, and the interrupt destination for the flow D is the CPU #3.

In the control data 111, for example, a flow in which an interrupt rate value in any of the CPUs 11 is equal to or greater than a predetermined threshold may be referred to as an interrupt-prone flow. Note that the method for specifying the interrupt-prone flow is not limited to this, and various modifications may be made. For example, a flow in which the interrupt rate value is prominently high may be determined as the interrupt-prone flow based on a relative relationship between a plurality of interrupt rate values recorded in the control data 111.

By referring to the control data 111, it becomes possible to easily grasp the interrupt-prone flow. The control data 111 is used for cooperation between the host and the DPU 18.

The update detection unit 104 obtains the control data 111 of the host. The update detection unit 104 reads the profile of the host from the control data 111, and checks whether the profile of the host has been updated.

The update detection unit 104 passes the obtained profile of the host to the interrupt processing distribution unit 105. The update detection unit 104 may store the obtained profile of the host in a predetermined storage area such as the memory 22, the storage device 23, or the like.

The update detection unit 104 performs Remote Direct Memory Access (RDMA) Read operation on the control data 111 to obtain a profile.

The function as the update detection unit 104 may be implemented by a control thread.

The switch profile acquisition unit 103 obtains a switch profile of the hardware switch 32. The switch profile may include settings and statistical information of the hardware switch 32.

The switch profile acquisition unit 103 notifies the interrupt processing distribution unit 105 of the obtained switch profile. The switch profile acquisition unit 103 may store the obtained switch profile in a predetermined storage area such as the memory 22, the storage device 23, or the like.

The function as the switch profile acquisition unit 103 may be implemented by a control thread.

The interrupt processing distribution unit 105 determines the CPU 11 as an interrupt destination based on the profile of the host obtained by the update detection unit 104 and the switch profile of the hardware switch 32 obtained by the switch profile acquisition unit 103.

The interrupt processing distribution unit 105 refers to the control data 111 to identify an interrupt-prone flow, and determines the identified interrupt-prone flow as an adjustment target flow.

The interrupt processing distribution unit 105 identifies, based on a state of each of the plurality of processors 11 (first processors 11), an adjustment target flow in which an interrupt frequently occurs in any processor 11 of those plurality of processors 11.

Furthermore, the interrupt processing distribution unit 105 determines, as a next interrupt destination, a CPU 11 of the plurality of CPUs 11, which is a CPU 11 other than the CPU 11 serving as a current interrupt destination, in which the interrupt rate value is smaller than a predetermined threshold.

The interrupt processing distribution unit 105 refers to the control data 111, and repeatedly determines (changes) the interrupt destination such that the CPU 11 of the interrupt destination is switched frequently (e.g., every several μ seconds to several 10μ seconds) when the HPC application 100 is running using all the CPUs 11.

The interrupt processing distribution unit 105 determines the interrupt destination for interrupt processing from among the plurality of processors 11 based on the state of each of the plurality of processors 11.

The interrupt processing distribution unit 105 notifies the switch control unit 106 of information for identifying the adjustment target flow and information for identifying the CPU 11 determined as the next interrupt destination, and issues a switch profile update request so that the switch profile of the hardware switch 32 is rewritten.

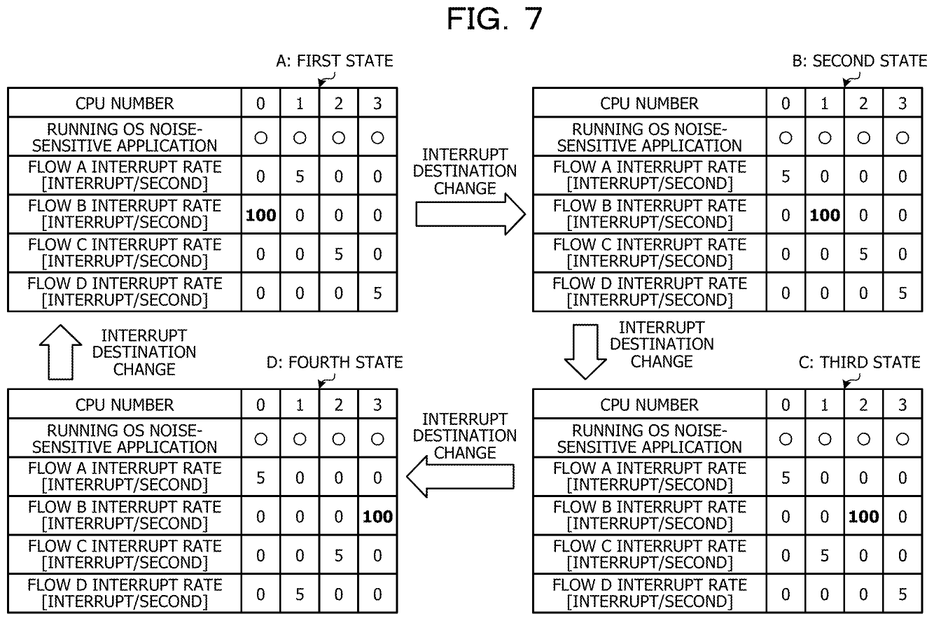

FIG. 7 is a diagram for explaining processing of the interrupt processing distribution unit 105 in the information processing apparatus 1 as an example of the first embodiment.

In this FIG. 7, a reference sign A, a reference sign B, a reference sign C, and a reference sign D indicate a first state, a second state, a third state, and a fourth state, respectively. Furthermore, the flow B is an interrupt-prone flow.

Furthermore, all the four CPUs 11 identified by the CPU numbers 0 to 3 are running the OS noise-sensitive HPC application 100.

In the first state, the interrupt destination is the CPU #0. In this first state, the interrupt processing distribution unit 105 notifies the switch control unit 106 of, together with the switch profile update request, the flow B and the CPU #1 as an adjustment target flow and a next interrupt destination, respectively, thereby shifting to the second state.

In the second state, the interrupt destination is the CPU #1. In this second state, the interrupt processing distribution unit 105 notifies the switch control unit 106 of, together with the switch profile update request, the flow B and the CPU #2 as an adjustment target flow and a next interrupt destination, respectively, thereby shifting to the third state.

In the third state, the interrupt destination is the CPU #2. In this third state, the interrupt processing distribution unit 105 notifies the switch control unit 106 of, together with the switch profile update request, the flow B and the CPU #3 as an adjustment target flow and a next interrupt destination, respectively, thereby shifting to the fourth state.

In the fourth state, the interrupt destination is the CPU #3. In this fourth state, the interrupt processing distribution unit 105 notifies the switch control unit 106 of, together with the switch profile update request, the flow B and the CPU #0 as an adjustment target flow and a next interrupt destination, respectively, thereby shifting to the first state.

Thereafter, similar processing is repeatedly executed, whereby the state transition from the first state to the fourth state is repeated. For example, the interrupt processing distribution unit 105 may determine the CPU 11 to be determined as a next interrupt destination of the adjustment target flow in rotation (on a rotation basis) among the plurality of CPUs 11.

The interrupt processing distribution unit 105 sequentially switches the next interrupt destination of the adjustment target flow between two or more processors 11 among the plurality of processors.

Furthermore, the interrupt processing distribution unit 105 repeatedly performs a series of processes including identification of the adjustment target flow, determination (change) of the interrupt destination, and issuance of the update request to the switch control unit 106 in a short time at intervals of, for example, several μ seconds to several 10μ seconds so that the repetition of the state transition (switching of the CPU 11 of the interrupt destination) exemplified in FIG. 7 is carried out at a high speed (e.g., at intervals of several μ seconds to several 10μ seconds).

As a result, while load states among the plurality of CPUs 11 are instantaneously biased in each of the states of the first to fourth states, the load state bias is distributed among the plurality of CPUs 11 in a predetermined span (e.g., 1 second), and the loads are equalized among the CPUs 11.

Furthermore, when the DPU 18 controls such interrupt distribution processing among the plurality of CPUs 11 performed by the interrupt processing distribution unit 105, the CPUs 11 are not used for the switching of the CPUs 11, and generation of the OS noise may be suppressed.

The function as the interrupt processing distribution unit 105 may be implemented by a control thread.

The switch control unit 106 controls the hardware switch 32.

The switch control unit 106 rewrites the switch profile of the hardware switch 32 according to the notification of the interrupt destination and the switch profile update request input from the interrupt processing distribution unit 105.

As a result, the switch profile of the hardware switch 32 is rewritten such that the interrupt destination is sequentially switched at a high speed (e.g., at intervals of several μ seconds to several 10λ seconds) among the plurality of CPUs 11.

The switch control unit 106 rewrites the switch profile of the hardware switch 32 with the information regarding the interrupt destination for the interrupt processing determined by the interrupt processing distribution unit 105.

The switch control unit 106 sets the per-CPU port 33b (per-processor virtual port) corresponding to the determined interrupt destination in the switch profile in accordance with an instruction from the interrupt processing distribution unit 105.

### (B) Operation

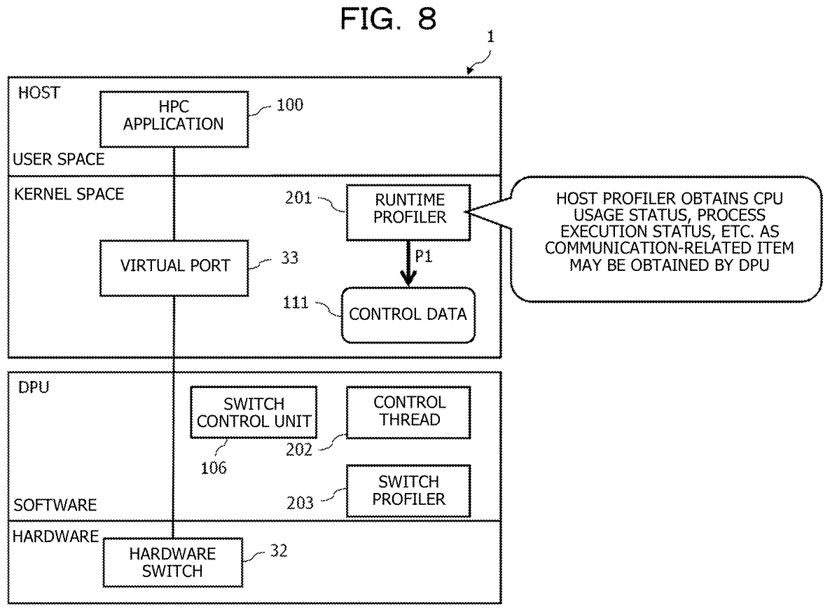

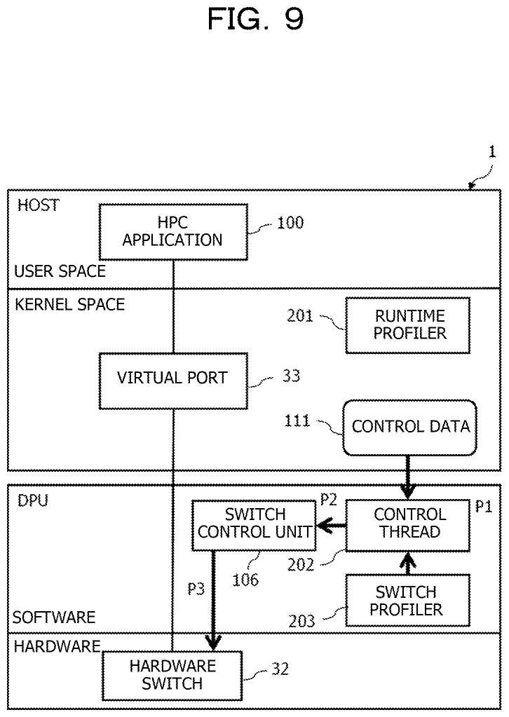

First, an outline of the interrupt distribution processing in the information processing apparatus 1 as an example of the first embodiment configured as described above will be described with reference to FIGS. 8 and 9. Note that FIG. 8 and FIG. 9 illustrate processing on the host side and processing on the DPU 18 side, respectively.

Furthermore, in those FIGS. 8 and 9, the processor 11 executes the runtime profiler 201 to implement the function as the host profile acquisition unit 102. Furthermore, the processor 21 of the DPU 18 executes a control thread 202 to implement the functions as the update detection unit 104 and the switch profile acquisition unit 103.

As illustrated in FIG. 8, the runtime profiler 201 obtains a usage status of each CPU 11 and a process execution status of each CPU 11. The runtime profiler 201 obtains the profile (performance profile) in the host, and stores it in the control data 111 (see reference sign P1 in FIG. 8).

Next, as illustrated in FIG. 9, the control thread 202 of the DPU 18 obtains the control data 111 by the RDMA Read (see reference sign P1 in FIG. 9). Furthermore, the control thread 202 also obtains the switch profile of the hardware switch 32.

The control thread 202 determines the CPU 11 as an interrupt notification input destination based on the profile of the host and the switch profile.

When the CPU 11 determined as the interrupt notification input destination is changed from the CPU 11 of the previous interrupt notification input destination, the control thread 202 issues a switch profile update request to the switch control unit 106 (see reference sign P2 in FIG. 9).

The switch control unit 106 rewrites the switch profile of the hardware switch 32 according to the notification of the interrupt destination and the switch profile update request input from the control thread 202 (see reference sign P3 in FIG. 9).

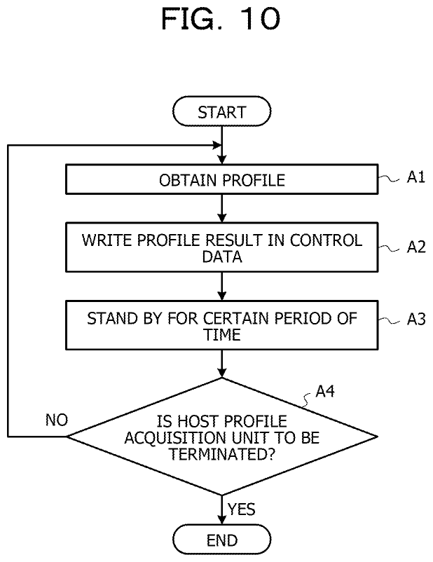

Next, processing of the host profile acquisition unit 102 in the information processing apparatus 1 as an example of the first embodiment will be described with reference to a flowchart (steps A1 to A4) illustrated in FIG. 10.

For example, this processing illustrated in FIG. 10 starts when the interrupt distribution processing in the present information processing apparatus 1 starts, and ends when the interrupt distribution processing is complete (e.g., when the power is shut down).

In step A1, the host profile acquisition unit 102 obtains a profile (performance profile) in the host.

In step A2, the control data management unit 101 writes the profile result obtained by the host profile acquisition unit 102 in the control data 111.

After a predetermined standby time has elapsed (temporary standby) in step A3, it is checked in step A4 whether to terminate the function as the host profile acquisition unit 102. For example, it may be determined that the end condition of the host profile acquisition unit 102 is satisfied when an input of a power shutdown of the present information processing apparatus 1 or the like is made.

Here, if the end condition of the host profile acquisition unit 102 is not satisfied (see No route of step A4), the process returns to step A1. On the other hand, if the end condition of the host profile acquisition unit 102 is satisfied (see Yes route of step A4), the process is terminated.

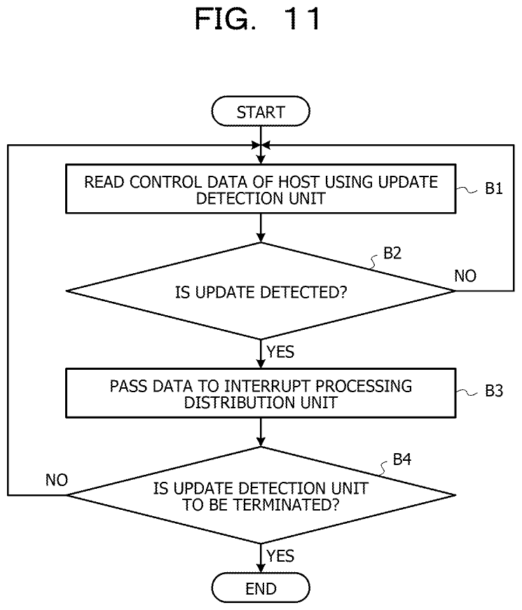

Next, processing of the update detection unit 104 in the information processing apparatus 1 as an example of the first embodiment will be described with reference to a flowchart (steps B1 to B4) illustrated in FIG. 11.

In step B1, the update detection unit 104 reads the control data 111 of the host.

In step B2, the update detection unit 104 refers to the read control data 111 to detect whether the profile of the host has been updated.

If no update is detected (see No route of step B2), the process returns to step B1. Furthermore, if the update is detected (see Yes route of step B2), the process proceeds to step B3.

In step B3, the update detection unit 104 passes the obtained profile of the host to the interrupt processing distribution unit 105.

In step B4, it is checked whether to terminate the function as the update detection unit 104. For example, it may be determined that the end condition of the update detection unit 104 is satisfied when an input of a power shutdown of the present information processing apparatus 1 or the like is made.

Here, if the end condition of the update detection unit 104 is not satisfied (see No route of step B4), the process returns to step B1. On the other hand, if the end condition of the update detection unit 104 is satisfied (see Yes route of step B4), the process is terminated.

### (C) Effects

As described above, according to the information processing apparatus 1 as an example of the first embodiment, the interrupt processing distribution unit 105 refers to the control data 111, and determines the adjustment target flow in which the interrupt frequently occurs.

Furthermore, the interrupt processing distribution unit 105 determines, as the next interrupt destination, the CPU 11 in which the interrupt rate value is smaller than the predetermined threshold from among the CPUs 11 other than the CPU 11 serving as the current interrupt destination among the plurality of CPUs 11.

As a result, it becomes possible to suppress concentrated occurrence of interrupts in a specific CPU 11, and to reduce generation of the OS noise. Furthermore, by suppressing the generation of the OS noise, it becomes possible to run the HPC application 100 without any concern for performance degradation even in the cloud, which may improve the cost performance.

Furthermore, the interrupt processing distribution unit 105 repeatedly performs a series of processes including identification of the adjustment target flow, determination (change) of the interrupt destination, and issuance of the update request to the switch control unit 106 in a short time at intervals of, for example, several μ seconds to several 10μ seconds so that the switching of the CPU 11 of the interrupt destination is carried out at a high speed (e.g., at intervals of several μ seconds to several 10μ seconds).

As a result, the load state bias is distributed among the plurality of CPUs 11 in a predetermined span (e.g., 1 second), and the loads are equalized among the CPUs 11. This may also reduce the generation of the OS noise.

Furthermore, with the functions as the update detection unit 104, the interrupt processing distribution unit 105, and the switch profile acquisition unit 103 being implemented in the DPU 18, the CPU 11 of the host is not used for the switching control of the interrupt destination. As a result, it becomes possible to reduce the load on each CPU 11, and to suppress the generation of the OS noise.

### (II) Description of Second Embodiment

In the first embodiment described above, the interrupt processing distribution unit 105 determines the CPU 11 to be determined as a next interrupt destination in rotation among the plurality of CPUs 11 when all the CPUs 11 are running the OS noise-sensitive HPC application 100, but it is not limited to this.

The interrupt processing distribution unit 105 may shift the adjustment target flow to the CPU 11 not running the OS noise-sensitive HPC application 100 when only some of the CPUs 11 among the plurality of CPUs 11 are running the OS noise-sensitive HPC application 100.

Whether the OS noise-sensitive HPC application 100 is running may be determined by setting the OS noise-sensitive HPC application 100 in advance and checking whether or not the application being run by the CPU 11 is the HPC application 100 registered in this setting.

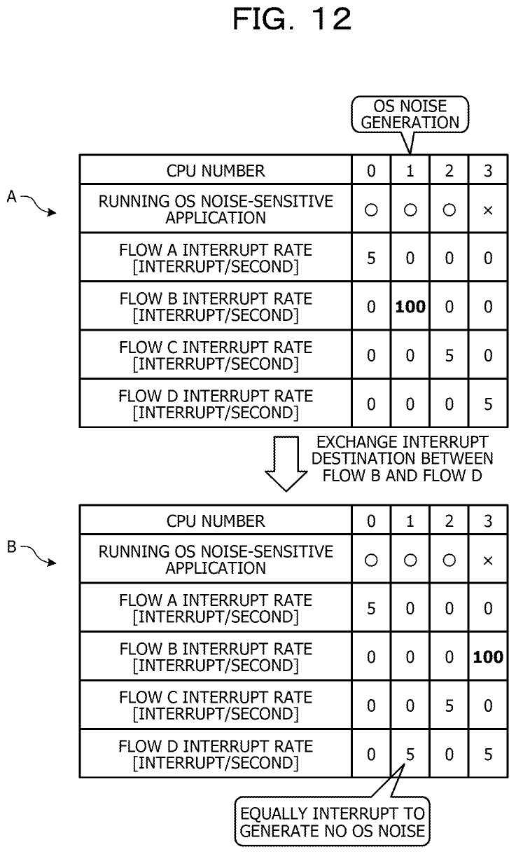

FIG. 12 is a diagram for explaining processing of an interrupt processing distribution unit 105 in an information processing apparatus 1 as an example of a second embodiment.

The information processing apparatus 1 in the second embodiment is configured in a similar manner to that in the first embodiment except that a method of determining a next interrupt destination in the interrupt processing distribution unit 105 is different from that of the first embodiment.

In FIG. 12, a reference sign A indicates a state before execution of interrupt distribution processing by the interrupt processing distribution unit 105, and a reference sign B indicates a state after execution of the interrupt distribution processing by the interrupt processing distribution unit 105.

This example illustrated in FIG. 12 indicates that, among CPUs #0 to #3, each of three CPUs #0 to #2 is running an OS noise-sensitive HPC application 100.

Furthermore, in the example illustrated in FIG. 12, as indicated by the reference sign A, while the CPU #3 is executing a flow D before the execution of the interrupt distribution processing by the interrupt processing distribution unit 105, it is not running the OS noise-sensitive HPC application 100. Moreover, an interrupt destination for a flow A is the CPU #0, an interrupt destination for a flow B is the CPU #1, an interrupt destination for a flow C is the CPU #2, and an interrupt destination for the flow D is the CPU #3. Furthermore, the flow B is an adjustment target flow.

In such a case, as indicated by the reference sign B, the interrupt processing distribution unit 105 changes the interrupt destination of the adjustment target flow B from the current CPU #1 to the CPU #3 not running the OS noise-sensitive HPC application 100. Meanwhile, the interrupt processing distribution unit 105 changes the interrupt destination for the flow D being executed by the CPU #3 to the CPU #1. For example, the interrupt processing distribution unit 105 exchanges the interrupt destination between the flow B and the flow D.

In the present second embodiment, the interrupt processing distribution unit 105 switches the next interrupt destination of the adjustment target flow to a processor 11 not running a processor noise-sensitive application among a plurality of processors 11.

As described above, the interrupt distribution processing shifts the interrupt destination of the adjustment target flow B from the CPU 11 running the OS noise-sensitive HPC application 100 to the CPU 11 not running the OS noise-sensitive HPC application 100. As a result, it becomes possible to suppress generation of the OS noise in the CPU 11 running the OS noise-sensitive HPC application 100. Furthermore, this makes it possible to run the HPC application 100 without any concern for performance degradation even in the cloud, which may improve the cost performance.

### (III) Others

Each configuration and each processing of the present embodiments may be selected or omitted as needed, or may be appropriately combined.

For example, when it is detected that some of the CPUs 11 have stopped running the OS noise-sensitive HPC application 100 in the state of the first embodiment in which all the CPUs 11 are running the OS noise-sensitive HPC application 100, the interrupt processing distribution unit 105 may shift the adjustment target flow to the CPU 11 not running the OS noise-sensitive HPC application 100 as in the second embodiment.

Furthermore, when it is detected that all the CPUs 11 are running the OS noise-sensitive HPC application 100 in the state of the second embodiment in which some of the CPUs 11 are not running the OS noise-sensitive HPC application 100, the interrupt processing distribution unit 105 may determine the CPU 11 to be determined as the next interrupt destination among the plurality of CPUs 11 in rotation as in the first embodiment.

Additionally, the disclosed technique is not limited to the embodiments described above, and various modifications may be made and implemented in a range without departing from the gist of the present embodiments.

For example, while it is indicated that the cloud virtual infrastructure may be Kubernetes in the embodiment described above, it is not limited to this. A method other than Kubernetes, such as docker, may be used as the virtual infrastructure. Furthermore, a virtual machine technique such as VMware may be used as the virtual infrastructure, which may be appropriately modified and implemented.

While the interrupt processing distribution unit 105 determines the CPU 11 to be determined as the next interrupt destination of the adjustment target flow in rotation (on a rotation basis) among the plurality of CPUs 11 in the first embodiment described above, it is not limited to this. For example, the interrupt processing distribution unit 105 may randomly select the CPU 11 to be determined as the next interrupt destination of the adjustment target flow from among the plurality of CPUs 11.

Furthermore, while the example in which the host profile acquisition unit 102 obtains the interrupt rate as a profile in the host has been described in the embodiment described above, it is not limited to this.

For example, for convenience, the number of packets per second may be treated as the number of interrupts per second by simplifying a case such that one interrupt occurs each time one packet is received. The unit of the number of packets per second may be represented by, for example, packet per second (pps).

Furthermore, the present embodiments may be carried out and manufactured by those skilled in the art according to the disclosure described above.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing a program for causing a computer to execute a data control process in an information processing apparatus including:
a plurality of first processors; and
a second processor that has a processing speed slower than the processing speed of the plurality of first processors, the process comprising:
causing the second processor to execute processing that determines an interrupt destination for interrupt processing from among the plurality of first processors based on a state of each of the plurality of first processors.

2. The non-transitory computer-readable recording medium according to claim 1, the recording medium storing the program for causing the computer to execute the data control process further comprising: causing the second processor to execute processing that rewrites a switch profile of a hardware switch with information of the determined interrupt destination for the interrupt processing.

3. The non-transitory computer-readable recording medium according to claim 2, the recording medium storing the program for causing the computer to execute the data control process further comprising:
setting a per-processor virtual port that corresponds to each of the plurality of first processors; and
causing the second processor to execute processing that sets the per-processor virtual port that corresponds to the determined interrupt destination in the switch profile.

4. The non-transitory computer-readable recording medium according to claim 1, wherein the second processor is included in a data processing unit (DPU).

5. The non-transitory computer-readable recording medium according to claim 1, the recording medium storing the program for causing the computer to execute the data control process further comprising:
specifying an adjustment target flow in which an interrupt frequently occurs in any first processor of the plurality of first processors based on the state of each of the plurality of first processors; and
causing the second processor to execute processing that sequentially switches a next interrupt destination of the adjustment target flow between two or more first processors among the plurality of first processors.

6. The non-transitory computer-readable recording medium according to claim 1, the recording medium storing the program for causing the computer to execute the data control process further comprising:
specifying an adjustment target flow in which an interrupt frequently occurs in any first processor of the plurality of first processors based on the state of each of the plurality of first processors; and
causing the second processor to execute processing that switches a next interrupt destination of the adjustment target flow to, of the plurality of first processors, a first processor in which an operating system (OS) noise-sensitive application is not being run.

7. A data control method in an information processing apparatus including:
a plurality of first processors; and
a second processor that has a processing speed slower than the processing speed of the plurality of first processors, the method comprising:
causing the second processor to execute processing that determines an interrupt destination for interrupt processing from among the plurality of first processors based on a state of each of the plurality of first processors.

8. The data control method according to claim 7, further comprising:
causing the second processor to execute processing that rewrites a switch profile of a hardware switch with information of the determined interrupt destination for the interrupt processing.

9. The data control method according to claim 8, further comprising:
setting a per-processor virtual port that corresponds to each of the plurality of first processors; and
causing the second processor to execute processing that sets the per-processor virtual port that corresponds to the determined interrupt destination in the switch profile.

10. The data control method according to claim 7, wherein the second processor is included in a data processing unit (DPU).

11. The data control method according to claim 7, further comprising:
specifying an adjustment target flow in which an interrupt frequently occurs in any first processor of the plurality of first processors based on the state of each of the plurality of first processors; and
causing the second processor to execute processing that sequentially switches a next interrupt destination of the adjustment target flow between two or more first processors among the plurality of first processors.

12. The data control method according to claim 7, further comprising:
specifying an adjustment target flow in which an interrupt frequently occurs in any first processor of the plurality of first processors based on the state of each of the plurality of first processors; and
causing the second processor to execute processing that switches a next interrupt destination of the adjustment target flow to, of the plurality of first processors, a first processor in which an operating system (OS) noise-sensitive application is not being run.

13. A information processing apparatus comprising:
a plurality of first processors; and
a second processor including a processing speed slower than the processing speed of the plurality of first processors and configured to:
execute processing that determines an interrupt destination for interrupt processing from among the plurality of first processors based on a state of each of the plurality of first processors.

14. The information processing apparatus according to claim 13, wherein the second processor executes processing that rewrites a switch profile of a hardware switch with information of the determined interrupt destination for the interrupt processing.

15. The information processing apparatus according to claim 14, wherein the second processor:
sets a per-processor virtual port that corresponds to each of the plurality of first processors; and
executes processing that sets the per-processor virtual port that corresponds to the determined interrupt destination in the switch profile.

16. The information processing apparatus according to claim 13, wherein the second processor is included in a data processing unit (DPU).

17. The information processing apparatus according to claim 13, wherein the second processor:
specifies an adjustment target flow in which an interrupt frequently occurs in any first processor of the plurality of first processors based on the state of each of the plurality of first processors; and
executes processing that sequentially switches a next interrupt destination of the adjustment target flow between two or more first processors among the plurality of first processors.

18. The information processing apparatus according to claim 13, wherein the second processor:
specifies an adjustment target flow in which an interrupt frequently occurs in any first processor of the plurality of first processors based on the state of each of the plurality of first processors; and
executes processing that switches a next interrupt destination of the adjustment target flow to, of the plurality of first processors, a first processor in which an operating system (OS) noise-sensitive application is not being run.
